(19) United States
(12) Patent Application Publication
(10) Pub. No.: US 2006/0155597 A1
(43) Pub. Date: Jul. 13, 2006

(54) Method, system and apparatus for location based advertising

(76) Inventor: David Martin Gleason, Phelan, CA (US)

Correspondence Address: MORGAN & FINNEGAN, L.L.P., 3 WORLD FINANCIAL CENTER, NEW YORK, NY, 10281-2101, US

(21) Appl. No.: 11/032,835

(22) Filed: Jan. 10, 2005

(51) Int. Cl. G06Q 30/00

(52) U.S. Cl. 705/14

(57) ABSTRACT

The invention relates to a method, system and apparatus for managing a small business' advertising. More specifically, the system creates and administers a virtual online world accessible to users (players) within a virtual environment. A player interacts with various elements of the virtual environment and during those interactions the advertising is displayed to the user. To subscribe to the virtual environment, a player provides user information through a registration process to create a user profile. The system selects and displays advertisements that are correlated to a given user. The correlation between advertisement and user in one embodiment of the invention is based on a user's zip code. Further, in order to facilitate the quick adoption of the system among small business owners, a fundraising paradigm is implemented. More specifically, people volunteer to sell advertising opportunities within a virtual environment in exchange for a share of sales revenues.

### FIELD OF INVENTION

This invention relates to directed advertising management based on system user characteristics. More specifically, the invention relates to a method, system and apparatus for distributing advertising information to participants in an online game, wherein the information is customized based on their location.

### BACKGROUND INFORMATION

Generally, local advertisers have not been able to effectively participate in the immense growth in the adoption of the internet. Quite simply, the breadth of the market exposure, which is the primary interest of any advertiser, associated with the internet is the very characteristic that prevents most small businesses from effectively advertising on the internet. More specifically, because a web advertisement is accessible by person at anytime, any where in the world, advertising on well known sites is quite simply cost-prohibitive. Therefore, the internet has been utilized primarily by large multi-national corporations that advertise based on the concept of mass-media epitomized by the internet. It has simply been difficult for a small business (e.g., Joe's Auto Repair) to use the internet to market the services/goods that the small business is offering.

For example, McDonalds, a corporation that has franchises placed throughout the world also has a significant annual advertising budget. Accordingly, because the corporation wants to achieve the broadest market coverage possible, pursuing internet advertising is an ideal way to market its products, even though there is significant cost involved. In contrast, Joe's Auto Repair does not necessarily want to incur significant costs, from what may be a relatively limited advertising budget, in order to advertise its services to the broadest possible group of people possible. This is due to the fact that the vast majority of people exposed to the advertising likely will not be able to obtain those services. (If the repair shop is located in Florida, few consumers are willing to drive from New York to get a good deal on an oil change.)

Accordingly, small businesses may turn to advertising methods with a limited circulation, such as running advertisements in a local newspaper or by participating in a direct mailing). Both of these methods of advertising still involve substantial constraints (newspaper advertisements and direct mailings involve print deadlines, there is often an additional cost for color advertisements, the number of colors used in the advertisement is often limited, a business may be limited with regard to the times/dates of circulation, etc . . . ). These are just a few of the shortcomings of advertising options available to the small business owner.

### SUMMARY OF THE INVENTION

Therefore, it is an object of the invention to provide a small business owner with the opportunity to the take advantage of the surge in popularity of the internet, as well as online gaming to overcome the deficiencies discussed above. To achieve this goal, the invention is a method, system and apparatus for managing a small business' advertising. Although, the invention significantly increases the efficacy of small business advertising, it is to be understood that both mid-sized and the large international business may also use the invention to reach a specific group of consumers.

The system is used to create and administer a virtual online world accessible to system users (players) that interact with various elements of the virtual world. Advertisements are presented to the players within the virtual world, the advertising is displayed to the user through a range of implementations. The implementations make be formed as incentive programming (e.g. award points as described in greater detail below), or by specific product/branding placement at advertisement locations within the virtual world.

In order to participate in the virtual world, a player provides user information through a registration process creating a user profile, as well as a character for use in the virtual world. Part of the registration process includes a player providing his/her zip code among other player-specific information. Alternately, the user may provide Global Position System (GPS) coordinates or identify their location on a map. Based on this information, the system customizes the virtual world to include certain advertisements selected based on geographic location (e.g., within a given zip code; a circular area with a predetermined radius centered around GPS coordinates or an identified area on a map; or any other designated geographic area, etc . . . ).

Accordingly, it is possible to provide local businesses within the player's real world environment to create and manage advertising directed at people who are located within a certain community (i.e., zip code, collection of zip codes, or any other portion of a geographic area). In this way, a small business may maximize their advertising budget and effectively target their advertising efforts. The advertising may be implemented in any number of embodiments any (or all) of which may be selected by a local business.

Another object of the invention involves implementing a user-friendly advertisement creation/editing tool that allows a business owner to effectively manage advertisements within the virtual world. In an embodiment of the invention, the advertiser may log onto the system to create/edit/manage advertisements associated with a specific business. In one embodiment of the invention, the advertiser is provided with a Graphical User Interface advertisement creation tool that allows the advertiser to easily customize advertisements, coupons and award certificates.

The advertisements may be statically/dynamically displayed within the virtual world. In another embodiment, the system includes a “coupon corner,” where system users can view coupons created by the various participating advertisers. Alternately, advertisements may be embedded within award certificates provided to a system user upon completion of a mini-game/online challenge. The award certificates/coupons may be created with individual serial numbers or bar codes for advertisement efficacy tracking (e.g., providing an advertiser with metrics that include the number of times the award certificate/coupon is viewed/printed/downloaded by a system user. Furthermore, it is to be understood, the system is directed to providing advertisers, who may not necessarily have extensive computer experience with an easy efficient way of advertising their product/services.

It is a further object of the invention to benefit fundraising entities, while facilitating the quick adoption of the system by game players and advertisers (sponsors), alike. More specifically, rather than rely on a hired sales force to sell advertising opportunities, according to one embodiment of the invention, advertising opportunities are sold primarily by fundraising groups, such a members of a town's Parent/Teach Association, a girl scout troop, or members of a soccer team. Accordingly, small business owners not only gain the benefits of directed advertising, they also reap the rewards of supporting the surrounding community, such as generating good will for their business. Other and further aspects of the invention will become apparent from the following detailed description with reference to the accompanying drawings.

### BRIEF DESCRIPTION OF THE DRAWINGS

FIGS. 1A-1E illustrate various advertising implementations available to a business owner in the present invention.

FIGS. 2A and 2B illustrate exemplary customizable advertisement distribution maps that assist an advertising user to determine how to direct advertising resources.

FIG. 3 illustrates an exemplary fund raising referral fee system according to an embodiment of the invention.

FIGS. 4A and 4B illustrate an exemplary implementation of an Ad Builder module and a representative banner advertisement created by the Ad Builder module, respectively.

FIG. 5 is a diagram illustrating hardware components and software modules associated with an embodiment of the invention.

With reference to the figures, various embodiments of the present invention will now be shown and described. The leading reference number for each item designates the first figure in which that item has been introduced.

### DETAILED DESCRIPTION OF THE INVENTION

In the following description of the various embodiments of the invention, reference is made to the accompanying drawings, which form a part hereof, and in which is shown by way of illustration various embodiments in which the invention may be practiced. It is to be understood that other advancing embodiments may be utilized, and structural and functional modifications may be made, without departing from the scope of the present invention.

Overview

The invention provides an efficient method, system and apparatus for managing and distributing advertisements for a small business. However, for the purposes of the discussion of the invention, it is to be understood that the advertising entity does not necessarily have to be a small business—both mid-level and large entities may also utilize the system for advertising. Furthermore, it is to be understood that system is generally used by one of two entities. The first is an entity that uses the system to create, edit and manage advertisement placements as the advertising user (usually a business owner), whereas an entity that uses the system for entertainment purposes (the target audience for the advertising user) will be discussed as a system user.

The invention may be discussed with regard to three primary elements: (1) the online management module; (2) the system user module; (3) the advertising user module and (4) the advertising management module. Generally, the online management module establishes the framework for the interactions between the system users (subscriber/players), the advertising users (advertising businesses) and the system. The advertising management module is related to creating/storing advertising and facilitates advertisement management functionality available to an advertising user. It is to be understood that the created advertising may be implemented in any number of forms including, but not limited to banner advertisements, coupons and/or award certificates. Further, the invention allows an advertising user to customize any number of advertisement parameters in the created advertisements, as will be discussed in greater detail below. The advertising management module also controls the fundraising aspects of the system, wherein a fundraiser refers an advertising user to the system provider in exchange for a portion of sales revenues. Aspects of these modules and their interactions will be discussed in greater detail below. System functionality has been significantly modularized so that the software controlling a system module may be easily modified/updated to add additional functionality or to take advantage of further technological developments.

Online Management Module

The online management module (omm) provides the foundation for the system. An embodiment of the invention may include implementing the omm as an online community (online game) customized for an individual user's interactions within a virtual world. Alternately, another embodiment may be configured as a Massive Multiplayer Online Game (MMOG). Further, it is to be understood that the invention is not constrained to game embodiments and may include online chat forums, or any other type of online registered user communities, including email systems search engines, online shopping communities, news distribution web sites, or any other online forum where a registered user is given access to a particular web site/online community. The individual system user embodiment of the invention will be discussed with regard to the accompanying figures.

Accordingly, the system is used to generate and maintain an online community or a “virtual world” wherein a system user may interact with various created software modules that provide the system user with a unique online experience. Another object of the omm is to provide advertising opportunities to advertising users as the system user interacts with the system. Accordingly, the specific implementation may vary greatly depending on the target advertising audience. By way of example only, assuming the target audience is pre-teen/teenage boys ages 11-15, the invention may be implement a mini-game\online challenge (discussed below) as a skate-boarding game. As such, it is possible to achieve a high degree of granularity for direct advertising based on a wide range of user characteristics.

Alternately, the invention may be implemented as an online game appealing to children ranging from ages 3-10. Accordingly, the implementation may include a popular children's fictional character and designed to impart knowledge ranging from simple skills safety to various educational lessons. Regardless of which implementation is selected, the online “virtual world” provides a forum for an advertising user to advertise their goods/services to any registered system user (game player).

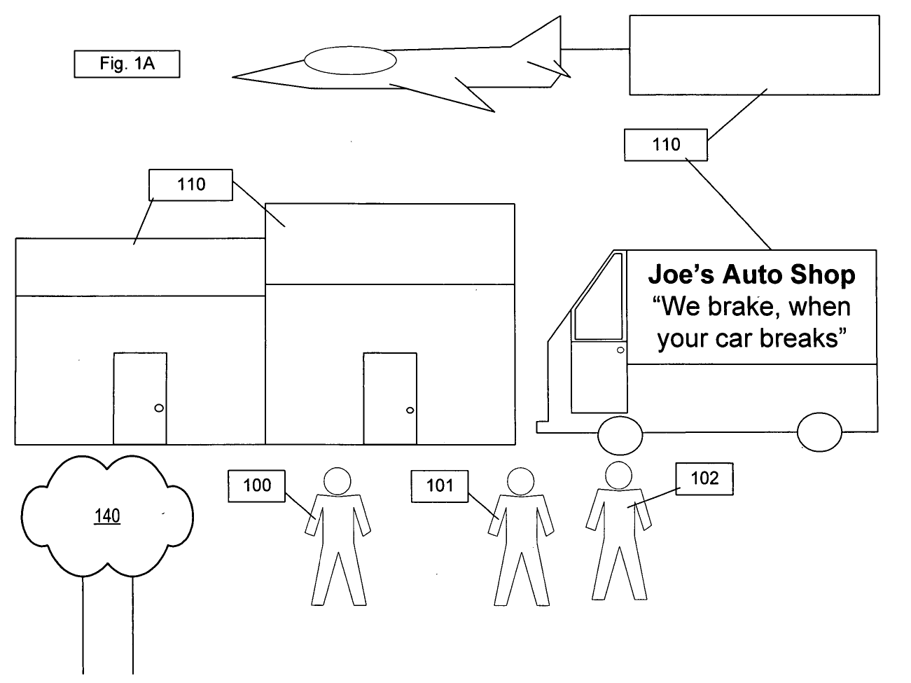

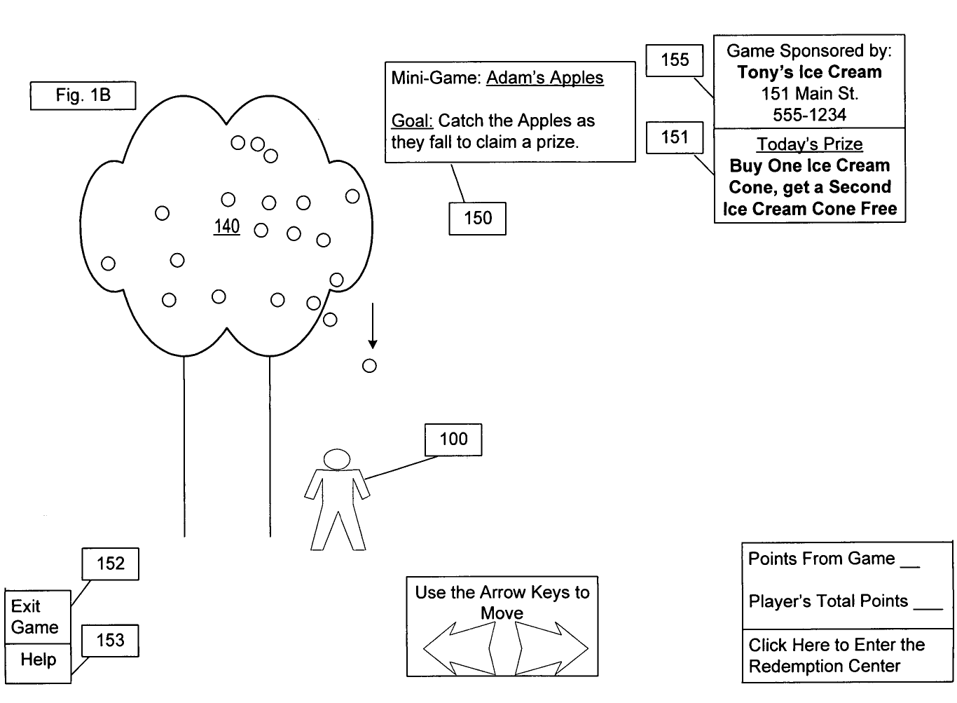

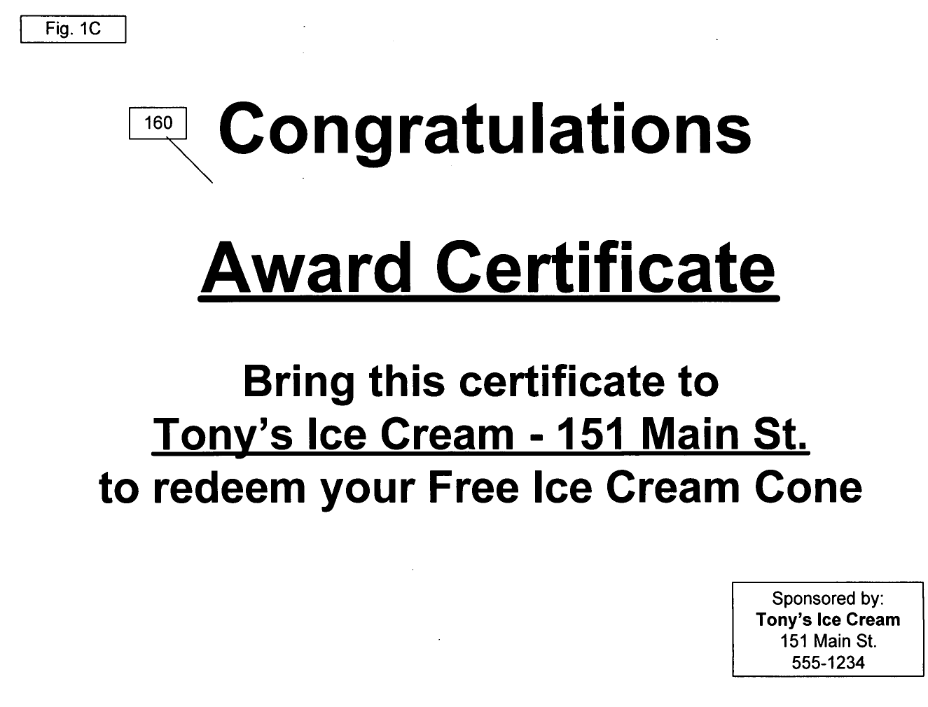

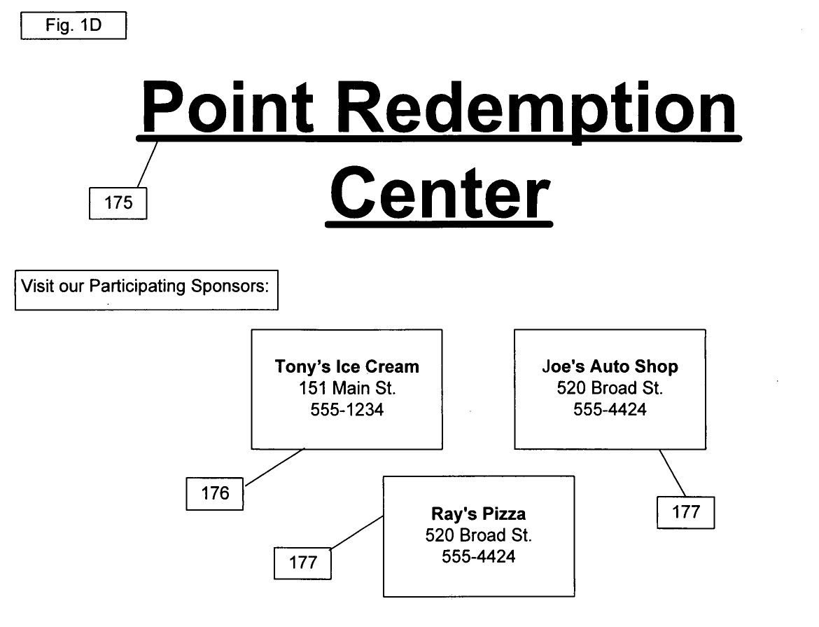

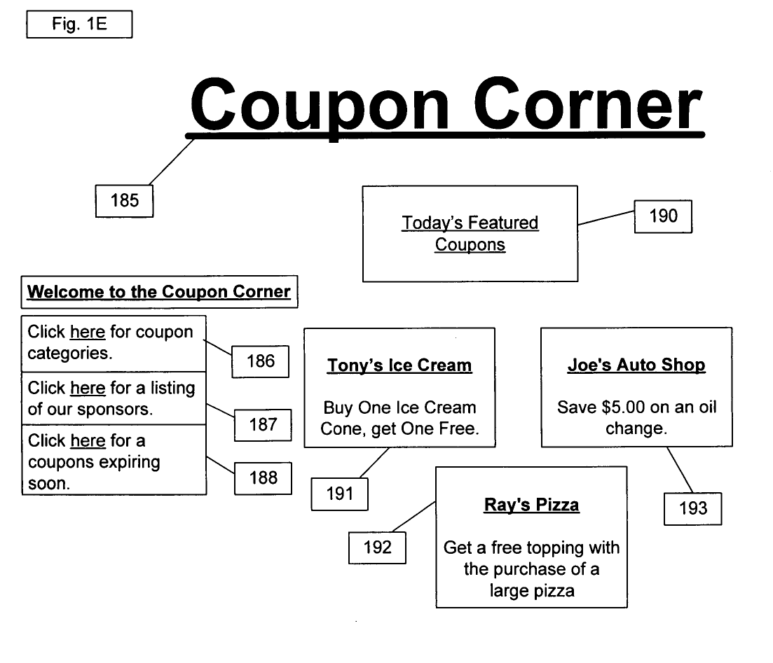

The online virtual world is configured as the forum to display advertisements to a system user. It is to be understood that the actual implementation of the advertisements may also vary greatly between embodiments. By way of example only, the embodiment of the invention implemented as a children's game may include three exemplary methods of providing advertising opportunities. As illustrated in FIG. 1A, a system user may use a children's character 100 for the purposes of exploring the virtual world. In this example, the virtual world is implemented as a small town 105. Accordingly, a game player (system user) 100 has the ability to explore a programmed virtual town 105. A first advertising method, a static method, involves placing product/service ads at various points within the virtual town 105. For example, rectangles 110, may be replaced with advertisements for particular stores (e.g., Tony's Ice Cream store, or Joe's Auto Repair). Depending on the actual implementation, advertisement displayed in the virtual town 105 may be placed based on either a fictional building or the building may be programmed to resemble an advertiser's actual place of business.

Moreover, FIG. 1B illustrates both static advertising implementations (placing an advertisement on a store front) and dynamic advertising implementations, wherein a user's actions result in additional advertising displays. For example, truck 120/airplane 125 may be animated to drive/fly periodically across the screen when a system user approaches a certain point in the virtual town 105. Additional advertisements may be linked to these animated elements. Further, as the game player explores the virtual town, he/she may be presented with the option to “enter” a particular store. Upon entering the store, the system user may have the option to purchase goods/services from the store or obtain additional information about the store or its products. Also, when a system user enters a store, the system user may be presented the opportunity to play a mini-game/online challenge.

FIG. 1B illustrates a dynamic advertisement implementation, wherein the system user participates in a game, or answers several questions to get a particular incentive. For example, FIG. 1B illustrates a simple game entitled, “Adam's Apples” 150. The game includes a brief set of “instructions” 151, an “exit” option 152, and/or a “more help” option 153. It is to be understood that Adam's Apples is an online mini-game/online challenge within the virtual town. The mini-game may be initiated as the system user 100 approaches a particular objects such as tree 140 (in FIG. 1).

Another advertising method involves correlating mini-games with an advertiser, which acts as a “sponsor.” For example, FIG. 1B illustrates elements of both static and dynamic advertising. Specifically, FIG. 1B includes a banner advertisement indicating that the game is sponsored by Tony's Ice Cream, as element 155. The game includes a simple interface that indicates the system user 100 is supposed to “catch the Apples as they fall . . . . ” Other exemplary games may include educational games, such as a word jumble/search and math games, or practical knowledge games designed to teach aspects of health or safety provisions, including skills associated with fire, traffic, water, personal, and/or environmental safety issues. Upon completion of the mini-game, the user may move onto the another round; the mini-game may be configured to present an award to the system user upon completion 160 (in FIG. 1C) or the game may award a user a certain number of award points 165 for successfully completing the mini-game. In other embodiments of the system, pointes may be used to rank system users 100 both on regional and national levels, with significantly larger prizes awarded to selected high achievers at these levels. A system user 100 may add the points earned in the mini-game to a total award point value and in certain embodiments of the invention enter a “point redemption center” 175.

As illustrated in FIG. 1D, the point redemption center 175, the system user is presented with several options. Specifically, the redemption center may be implemented with hotlinks to respective world-wide-web addresses associated with sponsor businesses (e.g., Tony's Ice Cream 176, Joe's Auto Shop 177, Ray's Pizza 178, etc . . . ). Alternately, the redemption center may present a user with a list of goods and corresponding point values, so that a system user may trade a certain amount of points for a certificate redeemable for the actual goods or a discount on the goods. Similarly, the system may be configured simply to award a certificate 160 for the goods or a discount upon completion of the game based on an advertiser's settings. In other embodiments of the invention, a system user may have the option to proceed directly to a “coupon center.” The coupon center is a module within the system where advertisers may deposit coupons that are available to all (or a selected group of) registered system users.

Although the invention, may be directed to primarily to game players and their interactions with the virtual world, the system may be configured to provide a “coupon corner” where any system user can access coupons created by and/or distributed by various advertising users. More specifically, a system user may select a link or enter an area in the virtual world, where advertisers have an opportunity to present coupons.

An exemplary coupon corner is illustrated in FIG. 1E. In the embodiment illustrated, advertisers are provided with the option to be a “featured coupon” 190. It is to be understood that the coupon corner 185 may be configured to illustrate advertisers' coupons based on the advertiser categories or sub-categories 186 (e.g., automotive/tires, oil changes, restaurants, etc . . . ), a complete listing of all advertisers/sponsors 187, the expiration date or any other method of arranging coupons for display. In the “Today's Featured Coupons” 190 configuration, the coupons may be presented as thumbnail images. A system user clicks on the thumbnail to open a printable version of the coupon. Exemplary advertisements are shown in FIG. 1E. Tony's Ice Cream presents a coupon for “Buy one ice cream cone, get one free” 191. Ray's Pizza has a coupon for a free topping with the purchase of a large pizza 192, and Joe's Auto Shop has a coupon for saving $5.00 on an oil change. Moreover, as discussed below coupons may be updated at any time and include a serial number used by the system to generate advertising efficacy metrics.

According to an alternate embodiment of the invention, the system may facilitate multiple characters interacting at the same time in the virtual town 105, as in a Massive Multi-player Online Game. Accordingly, as shown in FIG. 1A, characters 101 and 102, may represent two additional registered system users. It is to be understood that the individual some mini-games/online challenges may be designed as multi-player or single-player challenges. Furthermore, the system is designed to facilitate ongoing updates with fresh content (e.g., new mini-games and/or online challenges). The system may also be configured to support text and/or voice chat functionality for registered users.

System Users

As discussed above, the system is designed to expose a system user (game player) 100 to advertisements as the system user 100 interacts with various virtual town elements. Moreover, an objective of the invention is to provide small businesses an effective method of advertising on the internet. To achieve this goal, it is necessary to make advertising opportunities available at a reasonable price that also achieve a much more limited coverage area. The concept for effectively marketing a small business may be better demonstrated by a real world example. Assuming Joe's auto shop is located in California, Joe's small business should not spend portions of what may be a limited advertising budget on advertising oil changes to people located beyond a certain distance threshold. Joe may be better off focusing his advertising budget on efforts within his own and/or neighboring towns or communities. Joe should make an intelligent determination as to how broad his advertising coverage should be.

The efficacy of directed advertising is dramatically increased based on the available information associated with the target audience (registered system users). Therefore, the system requires system users to complete a registration process before logging onto the system for the first time. The system user registration process may vary between embodiments of the invention. In an embodiment, the system user registration process simply requires the system user to supply a zip code and/or GPS mapping coordinates associated with the primary location the system will be used.

In alternate embodiments, the registration process may require system user characteristics, including, but not limited to: age, gender, full address, sibling information (e.g., number of siblings, sibling age and sibling gender), household income, and any number of other characteristics that may be helpful for an advertising user to determine the scope (range) of an advertising user's target audience. Regardless of the breadth of the registration process, it at least includes the generation of a username and password for system users to sign onto the system. Based on the system user characteristics information supplied during the registration process, the system will create a virtual town 105 with advertisements tailored to those characteristics. For example, a system user located in zip code 90012 will experience a virtual town populated with advertisements from advertising users that request coverage in the 90012 zip code. Therefore, a system user located in zip code 90012, will most likely have a very different visual experience than a system user in zip code 11231.

Advertising Users

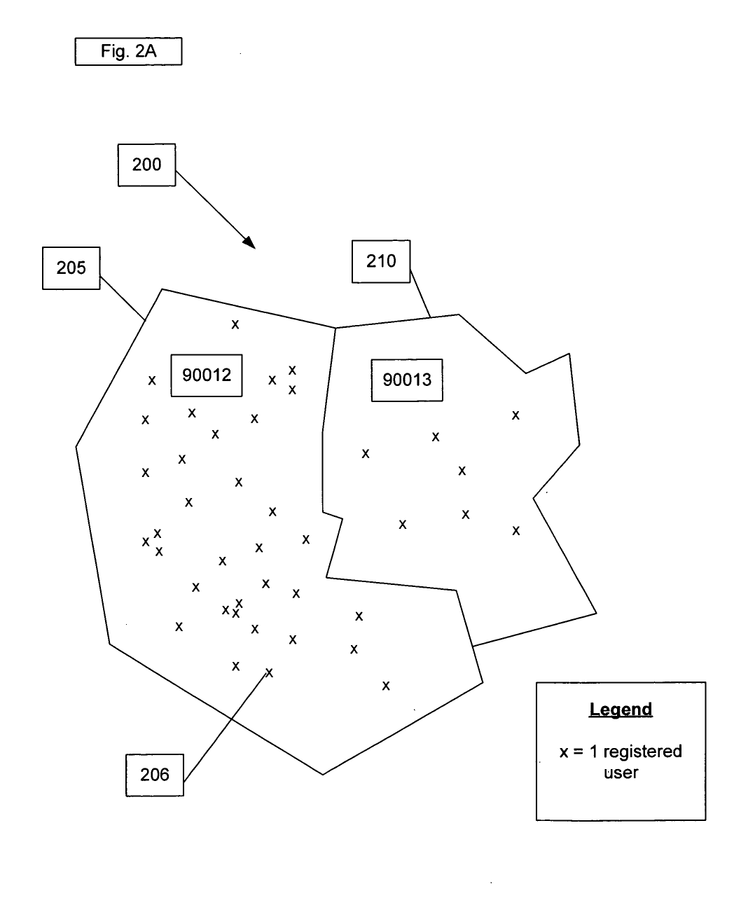

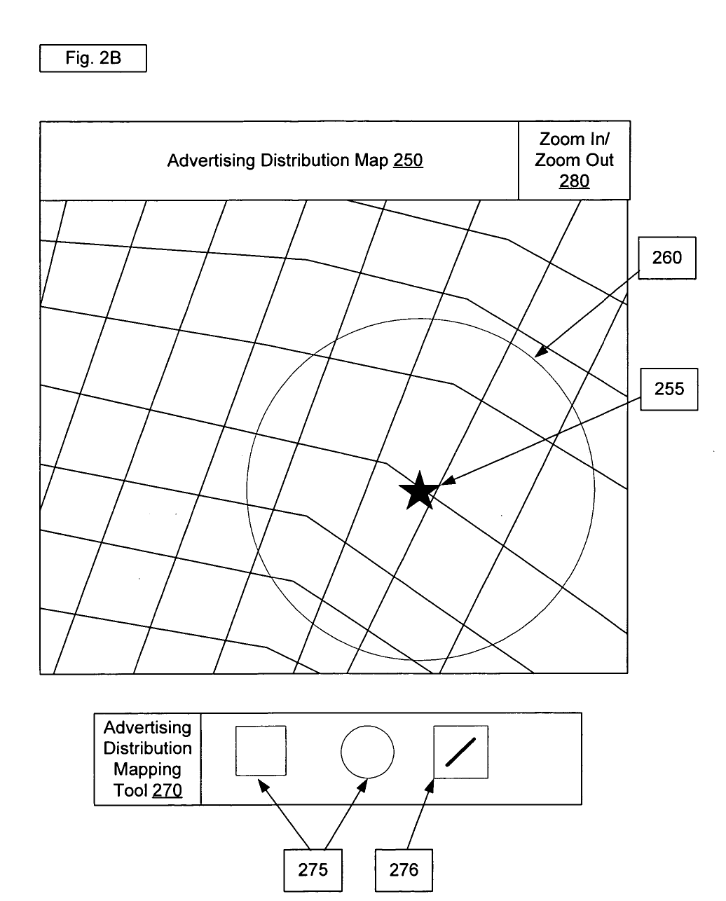

The system includes several modules that assist in efficiently optimizing a small business owner's advertising efforts. More specifically, the system includes an analysis tool that allows a small business owner to estimate the proper scope by illustrating the number of users within a given area. By way of example only, FIG. 2A illustrates a density map 200 of two specific representative advertising areas (zip codes 90012 and 90013) generated by an embodiment of the invention that illustrates the number of registered users within a given zip code. As illustrated, the zip code 90012 has a much higher population of registered users, where the registered users are represented as “x” characters 206. Also the system may implement any number of system user characteristics in a visualization 200. For example, the maps displayed to advertising users may implement any number of characteristics including age, gender or any other system user characteristic obtained during the registration process. Additionally, the information may be displayed based on time-dimensioned system use (i.e., a visualization may illustrate all users in a zip code that have logged onto the system within a three week period).

Accordingly, a small business owner is provided with the opportunity to visualize the distribution of a potential audience. The power of such a tool increases in direct proportion with how extensive the registration process is made. It is to be understood that the visualizations may be presented to the advertising user to determine the scope of local advertising. The advertising user has the ability to select either a single zip code and/or a predetermined area around GPS coordinates for narrow coverage or a series of zip codes for broader advertising coverage if desired.

The advertisement distribution area may also be location specific. More specifically, instead of implementing a zip code based advertisement distribution area, the advertising user may determine the coverage scope based on any number of different metrics (e.g., physical proximity, a viable delivery zone, etc . . . ). As shown in FIG. 2B, the system may be configured to present an advertising user with a map 250 generated based on a given address or GPS coordinates. For example, the owner of Joe's Auto shop located at 520 Broad St. is represented by a star 255. The system may be configured with a distribution mapping tool 270, whereby an advertising user may create a distribution area, such as circle 260. Joe may decide to advertise to registered users within a circular area that has a five mile radius with the auto shop located at the center of the circular area. The mapping tool may include preconfigured distribution areas such as a square or circle 275. It is to be understood that although the shapes may be provided to an advertiser, but the size of the distribution area on the map may be determined by the advertiser as needed. Alternately, the mapping tool may include a line creation tool 276, so that an advertiser may create a custom shape in order to customize the distribution area to fit their needs. In an embodiment, the advertising user may customize the granularity of the map by manipulating a zoom control module 280.

To sell advertising opportunities, it is possible to hire a group of salespeople to pitch the benefits associated with the system to small business owners. However, this would be prohibitive both in regard to the physical costs in labor and expenses. The best way to motivate a sales force is by giving the sales force a specific interest in their earning power.

According to one embodiment, this is achieved by implementing a type of fundraising distribution process. More specifically, fundraising groups, such as Parent Teacher Associations (PTAs and/or PTOs), boy scout troops or a high school basketball team may earn a commission consisting of a predetermined percentage of the proceeds generated by selling advertising space for a virtual town in a given area. Moreover, as discussed above, the advantages the system provides for a small advertiser over local newspaper advertising or direct mailings make fundraisers' jobs significantly easier.

The system may be configured to incorporate a revenue distribution module, wherein records are kept related to the numbers of advertiser referrals by a certain fundraiser. Upon reaching certain referral goals or other criteria a fundraiser may receive an additional incentive (e.g., an increased commission rate or a lump sum award). Further, the system may be configured to maintain records of cascading fundraisers (i.e., Fundraiser A introduces Fundraiser B to the system; Fundraiser A is given a share of revenue that Fundraiser B generates). When presented with opportunity to help facilitate the adoption of educational/safety based software that benefits both the system users, as well as the fundraisers, very often a small business owner will quickly accept the offer for reasonably priced advertising opportunities.

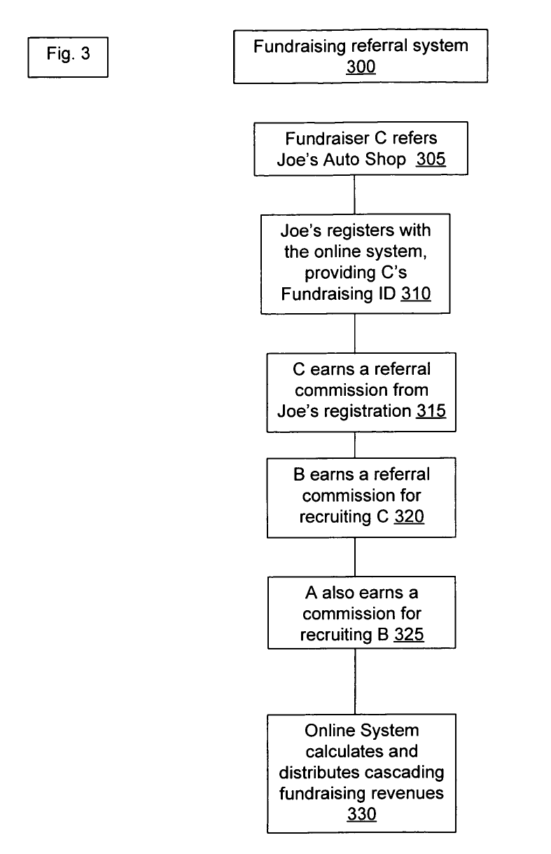

FIG. 3 illustrates a flow diagram related to fundraiser revenue distribution according to a cascading fundraising embodiment of the invention with Fundraiser C referring Joe's Auto Shop to the online system 305. By way of example only, Upon creating an advertisement, Joe's Auto Shop indicates that Fundraiser C referred Joe to the online system and should get fundraising credit for the sale 310. For purposes of this example, it is assumed Joe's Auto shop paid $10.00 for a one-month advertising opportunity. As the fundraiser closest to the sale of the advertising opportunity, Fundraiser C would get the largest commission 315 (portion of generated sales revenue), for example 50%. Further, according to the cascading fundraising of this embodiment, Fundraiser B who recruited/referred Fundraiser C to the online system would earn a commission 320, for example 10% of the sale, as a referral fee. Also, Fundraiser A who referred Fundraiser B would also earn a commission, for example 5% of the sale. Therefore the online system manager would earn 35% of the sale, while the various fundraisers would earn 65% of the sale. It is to be understood that the actual commission percentages, as well as the number of cascading fundraisers may vary between various implementations of the invention.

It is to be understood that the referring fundraisers/groups/individuals do not purchase or pay any fees to act as a recruiter/referring entity. Furthermore, the fundraisers may not necessarily actually conduct the sale, the sale may occur between online system management and the advertiser. The fundraiser may provide the advertiser with an identifier (serial number/group association value) that is keyed to the fundraiser. In turn, when the advertiser registers with the system/creates an advertisement, they may provide the fundraiser identifier that is used to by the system to control automatic distribute sales revenues to the various fundraisers 330.

Advertising Management

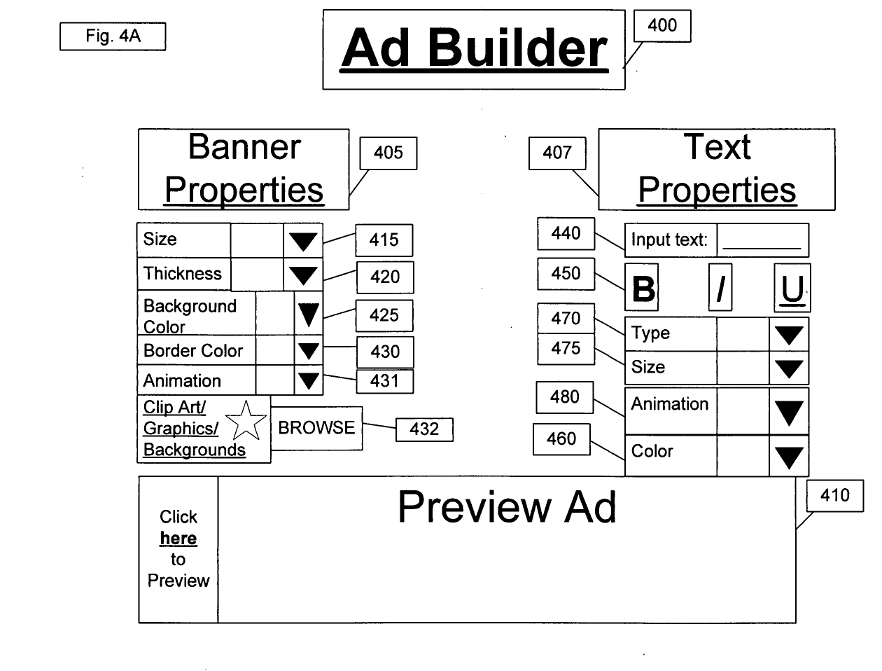

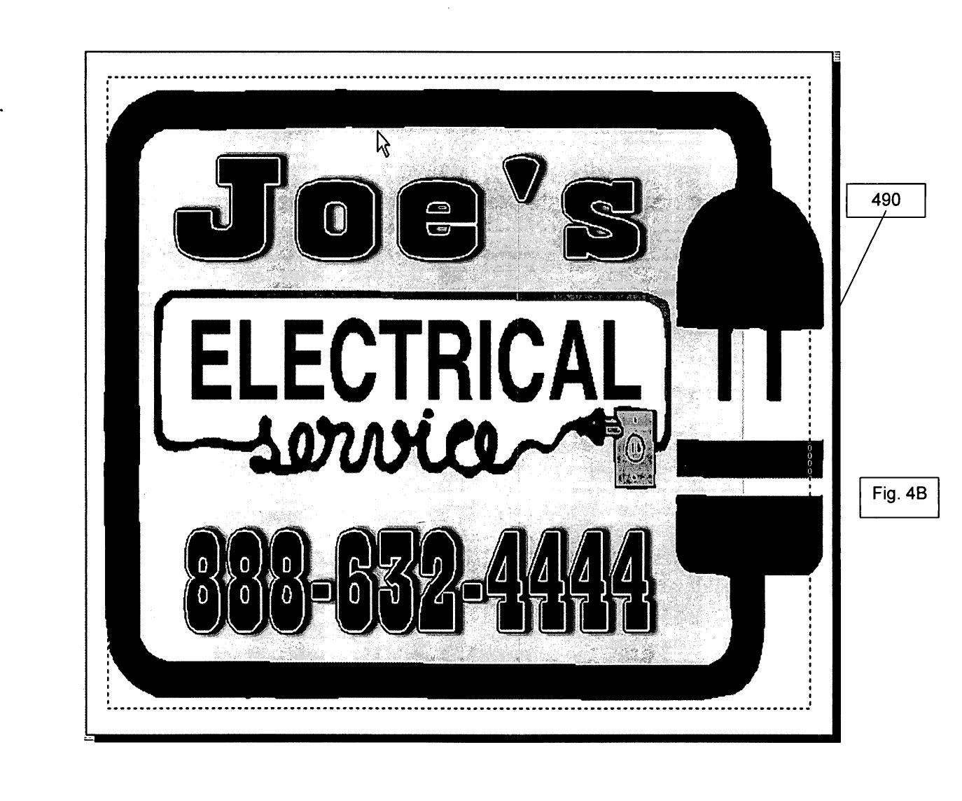

As an additional selling point, the system incorporates “Ad Builder” functionality that allows an advertising user to customize advertisement parameters associated with created/stored advertisements (e.g., banner advertisements, coupons, or award certificates, etc . . . ) at any time. This is a software module that assists the small business owner in creating, editing and managing advertisements for use in the virtual town. FIG. 4A illustrates several of the elements that facilitate point-and-click ad creation, editing, and management in the “Ad Builder” 400 associated with the system. More specifically, it is an object of the invention to provide an “Ad Builder” 400 that may be used by a small business owner who may have limited computer experience. As illustrated in FIG. 4A, to achieve this end, most of the advertisement editing tools are provided via drop-down boxes.

In FIG. 4A, Ad Builder 400 includes three elements related to editing advertisements: banner properties 405, text properties 407 and a preview ad box 410, which is configured to display the banner advertisement as it would appear to a system user. In one embodiment, the banner properties include banner size 415, border thickness 420, background color 425, border color/shadowing 430 and border animation 431. Also, the ad builder includes a clip art/graphics/background library 432 of pre-made forms that an advertiser may select and customize for their advertisement. The text editor 410 allows a user to manipulate the actual text used as input 440, toggle whether the text is bold, italicized, and/or underlined 450, the change the text color, and manipulate the font type 470, font size 475 and text animation 480 of the banner ad. Upon creation of an advertisement, the ad builder automatically places the ad in the virtual environment after receiving confirmation of payment and/or verification that the ad meets requirements established in the contract between the advertiser and the online system manager. A system administrator may configure the system to exclude ads based on characteristics such as, profanity, pornography or any other number of ad filters.

Moreover, the system provides a user with a dynamically updated advertisement preview window 410, so that the advertiser may view the ad in the same manner as the system user. An exemplary advertisement created with the Ad Builder for “Joe's Electrical Service 450 is illustrated in FIG. 4B. In addition to creating/editing ads, the Ad Builder may also be used to create coupons posted in the coupon corner discussed above to create coupons for users to print and redeem. It is to be understood that the coupons do not necessarily have be redeemed for points—they may be made readily available to all (or selected) users.

Advantageously, there are no printing deadlines associated with Ad Builder. The advertising user does not have to hire a graphic designer/typesetter to create the advertisement prior to submitting the advertisement for publishing (as is sometimes necessary with direct mailings or newspapers). Moreover, the advertising user is provided with access to an advertising portfolio that includes examples of various ads, fonts borders, animation, as well as all of the advertisements that the user created. The advertising user may access the advertising portfolio at any time and may create/edit/substitute advertisements at any time (although, there may be a log time for the system before the virtual form is updated).

The system may assign a serial number or other identifier to the advertisements in order to maintain advertising efficacy metrics when the advertisements are created (or imported). More specifically, when the coupon/award certificate is downloaded or printed, the system may generate and transmit a notification to the advertising user. Alternately, the system may generate efficacy metric logs that detail advertisement characteristics including, but not limited to viewing frequency, printing frequency, or other log characteristics. The efficacy log may be maintained in an advertising user databases on the system and/or periodically emailed to the advertising user.

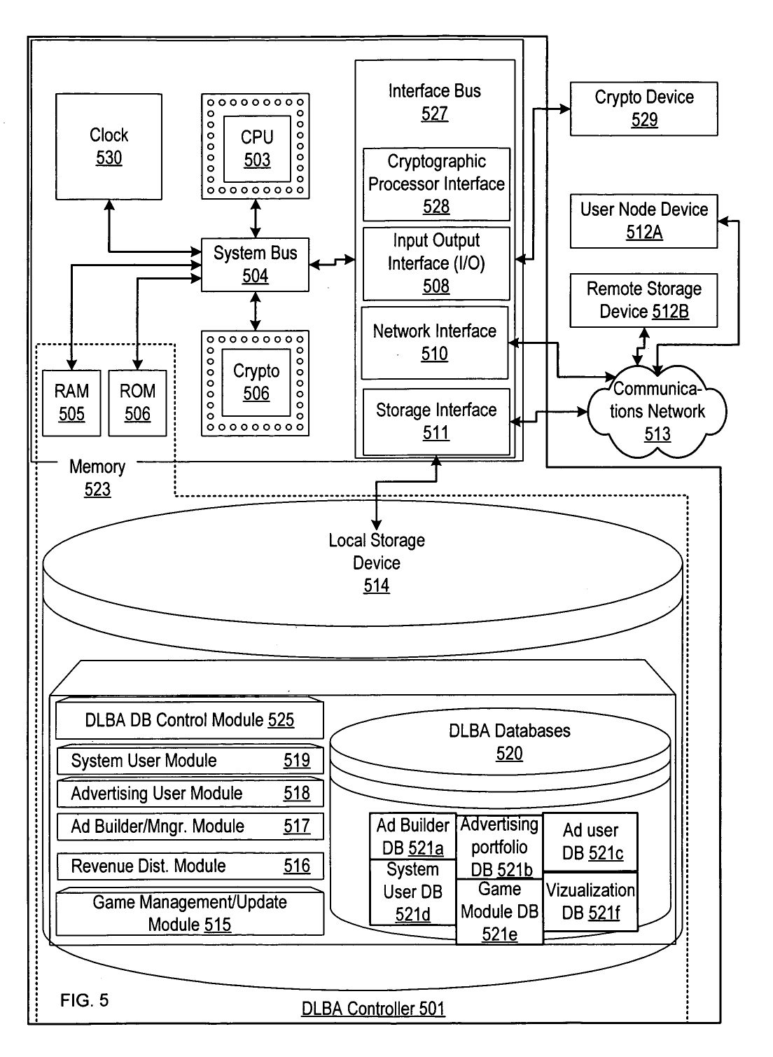

FIG. 5 is an exemplary diagram illustrating system elements associated with an embodiment of the Directed Location Based Advertising system (DLBA). The DLBA system controller 501 may be connected to and/or communicate with entities such as, but not limited to: one or more user nodes 512A, remote storage devices 512B connected through a communications network 513 and/or the internet. Depending on the actual implementation, the system may even be connected to and/or communicate with a cryptographic processor device 529 (for providing secure transactions).

The DLBA controller 501 may comprise a clock 530, central processing unit (CPU) 503, a read only memory (ROM 506), a random access memory (RAM 505), and/or an interface bus 527, and conventionally, although not necessarily, are all interconnected and/or communicating through a system bus 504. The system clock 530 typically has a crystal oscillator and provides a base signal. The clock is typically coupled to the system bus and various means that will increase or decrease the base operating frequency for other components interconnected in the computer systemization.

The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Optionally, a cryptographic processor 506 may similarly be connected to the system bus 504. Of course, any of the above components may be connected directly to one another, connected to the CPU, and/or organized in numerous variations employed as exemplified by various computer systems.

The CPU 503 comprises at least one high-speed data processor adequate to execute program modules for executing user and/or system-generated requests. The CPU 503 may be a microprocessor such as the Intel Pentium Processor and/or the like. The CPU 503 interacts with memory through signal passing through conductive conduits to execute stored program code according to conventional data processing techniques. Such signal passing facilitates communication within the DLBA system and beyond through various interfaces.

Interface Adapters

Interface bus(es) 527 may accept, connect, and/or communicate to a number of interface adapters, conventionally although not necessarily in the form of adapter cards, such as but not limited to: input output interfaces (I/O) 508, storage interfaces 511, network interfaces 510, and/or the like. Optionally, cryptographic processor interfaces 528 similarly may be connected to the interface bus 527. The interface bus 527 provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (PCI), Personal Computer Memory Card International Association (PCMCIA), and/or the like.

Storage interfaces 511 may accept, communicate, and/or connect to a number of storage devices such as, but not limited to: storage devices comprising local system resources including modules/databases 514, removable disc devices, and/or the like. Storage interfaces may employ connection protocols such as, but not limited to: (Ultra) Advanced Technology Attachment (Packet Interface) ((Ultra) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 510 may accept, communicate, and/or connect TFDDM with a communications network/the internet 513 and in turn, with user node(s) 512A. Network interfaces 510 may employ connection protocols such as, but not limited to: direct connect, Ethernet (thick, thin, twisted pair 10/100/1000 Base T, and/or the like), Token Ring, wireless connection such as IEEE 802.11a/b/g, Bluetooth, and/or the like. A communications network may be any one and/or the combination of the following: a direct interconnection; the Internet; a Local Area Network (LAN); Storage Area Network (SAN), Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface.

Input Output interfaces (I/O) 508 may accept, communicate, and/or connect to cryptographic processor devices 529, alternate system input device (not shown) and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394; infrared; joystick; keyboard; midi; optical; PC AT; PS/2; parallel; radio; serial; USB; video interface: BNC, composite, digital, RCA, S-Video, VGA, and/or the like; wireless; and/or the like. A common output device is a video display, which typically comprises a CRT or LCD based monitor with an interface (e.g., VGA circuitry and cable) that accepts signals from a video interface. The video interface composites information generated by a computer systemization and generates video signals based on the composited information. Typically, the video interface provides the composited video information through a video connection interface that accepts a video display interface (e.g., a VGA connector accepting a VGA display cable).

User node device(s) 512A may be connected and/or communicate with or to I/O Interface 508 and/or with or to other facilities of the like such as network interfaces 510, storage interfaces 511, and/or the like. A user node device 512A may be connected with a range of peripheral devices configured to interact with a user. Such peripherals may include cameras, dongles (for copy protection, ensuring secure transactions as a digital signature, and/or the like), external processors (for added functionality), goggles, microphones, microscopes, anatomical or cellular imaging systems, monitors, network interfaces, printers, scanners, storage devices, visors, and/or the like.

Cryptographic units such as, but not limited to, microcontrollers, processors 506, interfaces 527, and/or devices 528 may be attached, and/or communicate the DLBA system. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868, Mykotronx 24 MHz MYK-82A, or Semaphore Communications' 40 MHz Roadrunner 284.

Memory

A local storage device for storing the system modules/databases 514 may be any conventional computer system storage. Storage devices may be a fixed hard disk drive, and/or other devices of the like. However, it is to be understood that the DLBA system may employ various forms of memory 523 and that the various modules comprising the system are not limited to residing in the same memory. In a typical configuration, memory 523 will include ROM 505, RAM 506, and a local storage device 514. Generally, any mechanization and/or embodiment allowing a processor to affect the storage and/or retrieval of information is regarded as memory 523. Thus, a computer systemization generally requires and makes use of memory. However, memory is a fungible technology and resource, thus, any number of memory embodiments may be employed in lieu of or in concert with one another.

Module Collection

The local storage device 514 may contain a collection of program and/or database modules and/or data such as, but not limited to: DLBA local database controller module 525 (controls the storage of data entries locally); a system user module 519 (facilitates system user/system interactions); an advertising user module 518 (facilitates advertising user/system interactions); an Ad Builder/advertisement manager module 517 (controls the creation/editing of advertisements by the advertising user); a revenue distribution module 516 (automates the fundraising commission payout process); and a game management/update module 515 (controls rendering the virtual town/online challenges/award point management) and the DLBA system databases 520. The DLBA databases 520 are partitioned to manage information associated with the Ad Builder 521a, the Advertising Portfolio 521b, the advertising user 521c, the system user 521d, the gaming module 521e and the visualizations for determining advertising coverage 521f.

These modules may be stored and accessed from the local storage device 514 and/or from storage devices accessible through an interface bus. If necessary software modules such as those in the module collection, may be loaded and/or stored in memory such as: peripheral devices, RAM, remote storage facilities through a communications network, ROM, various forms of memory, and/or the like. The functionality associated with the DLBA system modules and databases will be described in greater detail below.

The DLBA system database 520 may be embodied in a database that is stored program code and executed by the CPU 503. The stored program code portion configures the CPU to process the data stored in the database. The databases may be conventional, fault tolerant, relational, scalable, extensible and secure databases. Relational databases are an extension of a flat file, and are collections of such.

Finally, it is to be understood that the logical and/or topological structure of any combination of the module collection and/or the present invention as described in the figures and throughout are not limited to a fixed execution order and/or arrangement, but rather, any disclosed order is exemplary and all functional equivalents, regardless of order, are contemplated by the disclosure. Furthermore, it is to be understood that such structures are not limited to serial execution, but rather, any number of threads, processes, services, servers, and/or the like that may execute asynchronously, simultaneously, synchronously, and/or the like are contemplated by the disclosure.

The many features and advantages of the present invention are apparent from the detailed specification, and thus, it is intended by the appended claims to cover all such features and advantages of the invention which fall within the true spirit and scope of the invention. Furthermore, since the embodiments described above are exemplary, numerous modifications and variations will readily occur to those skilled in the art, and the invention should not be limited to the exact construction and operation illustrated and described herein.

We claim:

1. A method for using a computer system to manage advertising data comprising:
registering a system user as part of an online community;
extracting user data from information stored during the registration process;
determining a geographic zone corresponding to the extracted system user data;
displaying advertising data to the system user based on the geographic zone, wherein the advertising data is created by an advertising user for placement within the online community and the advertising is displayed in response to system user interaction with elements of the online community.

2. The method of claim 1, further comprising:
distributing sales revenue to at least one fundraising referral entity.

3. The method of claim 2, further comprising:
distributing sales revenue to multiple fundraising referral entity according to a cascading referral implementation.

4. The method of claim 2, wherein the geographic zone is designated by the advertising user.

5. The method of claim 4, wherein the geographic zone is based on a system user's zip code.

6. The method of claim 4, wherein the geographic zone is based on GPS coordinates.

7. The method of claim 2, wherein the advertising data is configured as an award certificate created by the advertising user on the system.

8. The method of claim 2, wherein a portion of the advertising data is configured as at least one coupon created by the advertising user on the system.

9. The method of claim 8, wherein coupons created by the advertising user are displayed to the system user in a designated coupon area of the online community.

10. The method of claim 2, wherein a portion of the advertising data is configured as at least one award certificate created by the advertising user on the system.

11. The method of claim 10, wherein the award certificate is presented to a system user upon the completion of a mini-game.

12. The method of claim 2, wherein a portion of the advertising data is configured as at least one banner advertisement created by the advertising user on the system.

13. The method of claim 2, wherein the online community is implemented as an online game.

14. The method of claim 13, wherein the advertising data is displayed to the system user as the system user interacts with elements of the online game.

15. The method of claim 14, wherein the system user accrues award points during interactions with elements of the online game.

16. The method of claim 15, wherein the system user is able to redeem award points in an redemption area of the online community.

17. The method of claim 14, wherein the online game is a multi-player online game.

18. The method of claim 17, wherein the advertising data is displayed to the system user as the system user interacts with elements of the multi-player online game.

19. The method of claim 18, wherein the system user accrues award points during interactions with elements of the online game.

20. The method of claim 19, wherein the system user is able to redeem award points in an redemption area of the online community.

21. The method of claim 2, further comprising:
generating the advertising data with a graphical user interface configured to customize advertisement parameters.

22. The method of claim 21, further comprising:
creating an advertising user's portfolio for storing advertisements generated by the advertising user.

23. The method of claim 21, further comprising:
creating at least one advertising efficacy metric associated with an advertisement.

24. The method of claim 23, wherein the advertising efficacy metric is associated with the advertisement by an advertisement identifier assigned to the advertisement when it is created.

25. A system for using a computer system to manage advertising data comprising:
a memory having program code stored therein;
a processor operatively connected to said memory for carrying out instructions in accordance with said stored program code, wherein said program code, when executed by said processor causes said processor to:
register a system user as part of an online community;
extract user data from information stored during the registration process;
determine a geographic zone corresponding to the extracted system user data;
display advertising data to the system user based on the geographic zone, wherein the advertising data is created by an advertising user for placement within the online community and the advertising is displayed in response to system user interaction with elements of the online community.

26. The system of claim 25, further comprising:
distribute sales revenue to at least one fundraising referral entity.

27. The system of claim 26, further comprising:
distribute sales revenue to multiple fundraising referral entity according to a cascading referral implementation.

28. The system of claim 26, wherein the geographic zone is designated by the advertising user.

29. The system of claim 28, wherein the geographic zone is based on a system user's zip code.

30. The system of claim 28, wherein the geographic zone is based on GPS coordinates.

31. The system of claim 26, wherein the advertising data is configured as an award certificate created by the advertising user on the system.

32. The system of claim 26, wherein a portion of the advertising data is configured as at least one coupon created by the advertising user on the system.

33. The system of claim 32, wherein coupons created by the advertising user are displayed to the system user in a designated coupon area of the online community.

34. The system of claim 26, wherein a portion of the advertising data is configured as at least one award certificate created by the advertising user on the system.

35. The method of claim 34, wherein the award certificate is presented to a system user upon the completion of a mini-game.

36. The system of claim 26, wherein a portion of the advertising data is configured as at least one banner advertisement created by the advertising user on the system.

37. The system of claim 26, wherein the online community is implemented as an online game.

38. The system of claim 37, wherein the advertising data is displayed to the system user as the system user interacts with elements of the online game.

39. The system of claim 38, wherein the system user accrues award points during interactions with elements of the online game.

40. The system of claim 39, wherein the system user is able to redeem award points in an redemption area of the online community.

41. The system of claim 37, wherein the online game is a multi-player online game.

42. The system of claim 41, wherein the advertising data is displayed to the system user as the system user interacts with elements of the multi-player online game.

43. The system of claim 42, wherein the system user accrues award points during interactions with elements of the online game.

44. The system of claim 43, wherein the system user is able to redeem award points in an redemption area of the online community.

45. The system of claim 26, wherein the processor is further configured to:
generate the advertising data with a graphical user interface configured to customize advertisement parameters.

46. The system of claim 45, wherein the processor is further configured to:
create an advertising user's portfolio for storing advertisements generated by the advertising user.

47. The system of claim 45, wherein the processor is further configured to:
create at least one advertising efficacy metric associated with an advertisement.

48. The system of claim 47, wherein the advertising efficacy metric is associated with the advertisement by an advertisement identifier assigned to the advertisement when it is created.
